(19) United States
(12) Patent Application Publication
(10) Pub. No.: US 2010/0054955 A1
(43) Pub. Date: Mar. 4, 2010

(54) Blades

(75) Inventors: Caner H. Helvaci, Coventry (GB); Roderick M. Townes, Derby (GB); Stephen Diamond, Firenze (IT)

Correspondence Address: OLIFF & BERRIDGE, PLC, P.O. BOX 320850, ALEXANDRIA, VA, 22320-4850, US

(73) Assignee: ROLLS-ROYCE, PLC, LONDON (GB)

(21) Appl. No.: 12/458,540

(22) Filed: Jul. 15, 2009

(30) Foreign Application Priority Data
Sep. 3, 2008 (GB) 0815957.6

(51) Int. Cl. F01D 5/18; B23P 15/04

(52) U.S. Cl. 416/97 R; 29/889.721

(57) ABSTRACT

A rotary blade, such as a turbine blade for a gas turbine engine, has an aerofoil portion with a tip partly shrouded by winglets. A gutter extends across the radially outer face of the tip to leave upstands. Cooling air feed galleries are drilled into each upstand, from the trailing edge, toward the upper end of a cooling air feed void, which is spaced from the trailing edge. Cooling passages are drilled from the winglet edges to the gallery. Cooling air supplied through the void passes along the gallery, through the passages and leaves the blade at the cooling holes. This allows cooling to be provided near the trailing edge of the tip without requiring the geometry around the trailing edge to be thickened to accommodate a cooling air void.

The present invention relates to rotor blades.

Rotor blades are used in gas turbine engines as turbine blades to interact with combustion gases to convert kinetic energy of the combustion gases into rotation of the rotor. Rotor blades are also used as compressor blades to provide compression of the gases, prior to combustion. The efficiency of the engine is affected by the manner in which the combustion gases flow around the rotor blades. Accordingly, it is common practice to provide winglets at the blade tips, particularly for turbine blades. The winglets provide a shrouding effect to reduce losses associated with over-tip leakage. The performance and longevity of the rotor blades is also affected by the high temperatures experienced during engine running and accordingly, it is known to provide cooling air to surfaces of rotor blades, by means of internal passages and cooling holes.

Examples of the present invention provide a rotor blade comprising:

an aerofoil portion which extends radially to a tip;

a winglet at the tip and projecting transversely, to a winglet edge, to shroud the tip;

a gutter extending across the radially outer face of the tip;

the winglet providing an upstand between the winglet edge and the gutter;

and the blade further comprising a cooling air feed gallery and at least one cooling passage extending from the feed gallery to a cooling hole at an outer surface of the blade;

and the feed gallery being defined, at least in part, within the upstand.

Examples of the present invention also provide a method of manufacturing a rotor blade, in which:

an aerofoil portion is provided, extending radially to a tip;

a winglet is provided at the tip and projecting transversely, to a winglet edge, to shroud the tip;

a gutter is provided across the radially outer face of the tip, so that the winglet provides an upstand between the winglet edge and the gutter;

and a cooling air feed gallery and at least one cooling passage is provided within the blade, the or each cooling passage extending from the feed gallery to a cooling hole at an outer surface of the blade;

and the feed gallery is formed, at least in part, within the upstand. Additional features of examples of the invention are set out in the attached claims, to which reference should now be made.

Examples of the present invention will now be described in more detail, by way of example only, and with reference to the accompanying drawings, in which:

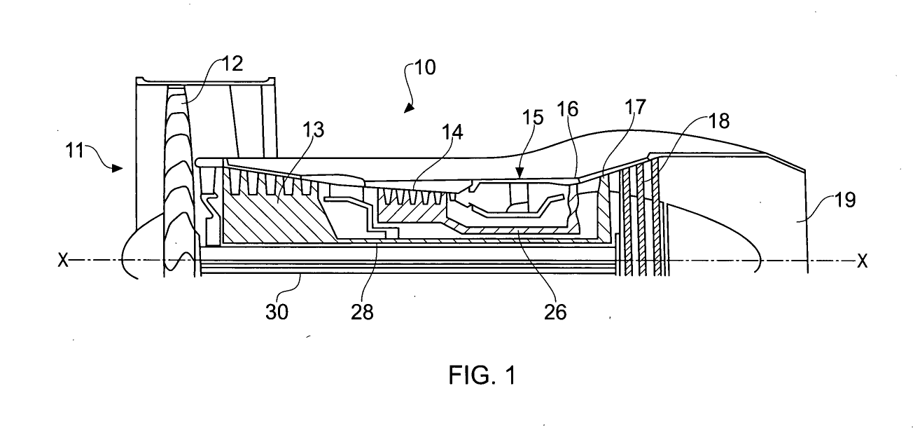

FIG. 1 is a section through a gas turbine engine;

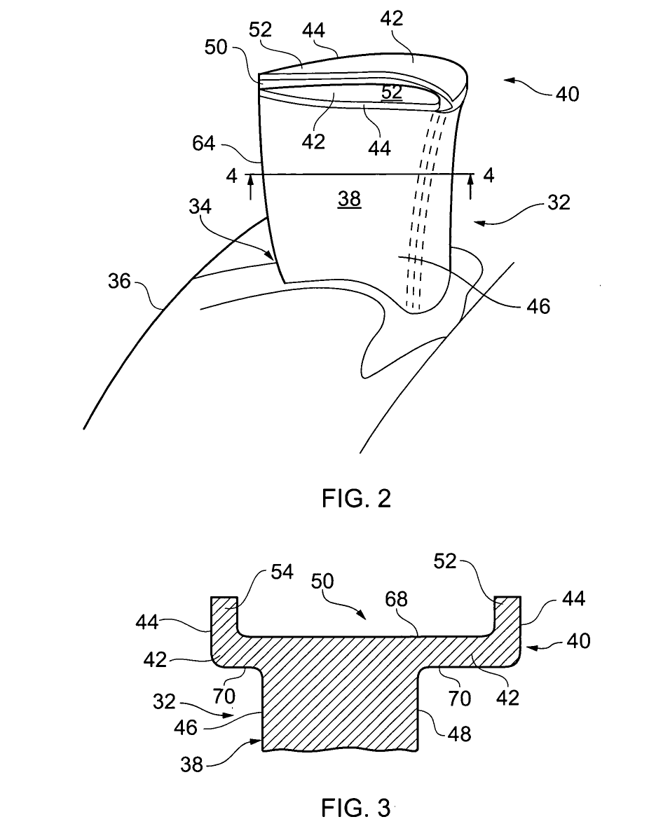

FIG. 2 is a perspective view of a rotor blade for the engine;

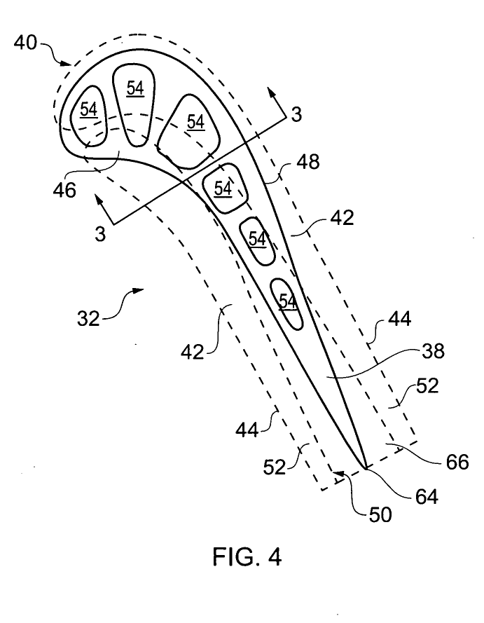

FIG. 3 is a section at the tip of the blade, on the line 3-3 of FIG. 4;

FIG. 4 is a section of the blade, on the line 4-4 of FIG. 2;

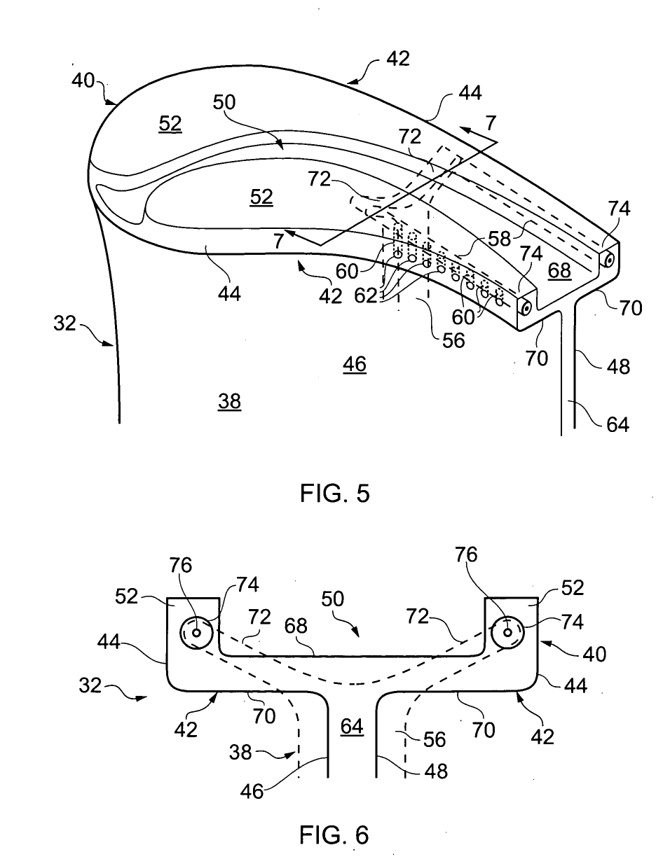

FIG. 5 is an enlarged perspective view of the tip of the blade;

FIG. 6 is an elevation view from the trailing edge of the blade; and

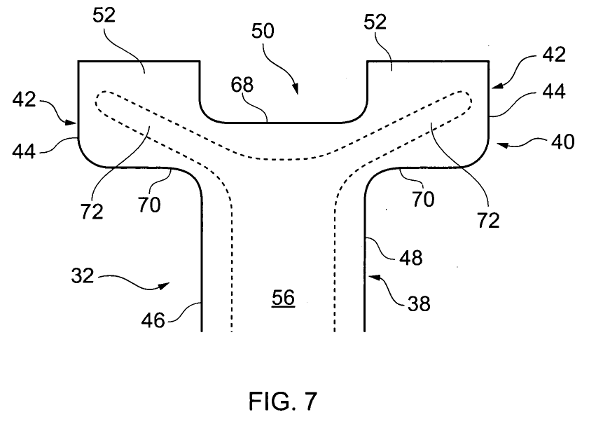

FIG. 7 is a section of the blade at the line 7-7 in FIG. 5.

Referring to FIG. 1, a gas turbine engine is generally indicated at 10 and comprises, in axial flow series, an air intake 11, a propulsive fan 12, an intermediate pressure compressor 13, a high pressure compressor 14, a combustor 15, a turbine arrangement comprising a high pressure turbine 16, an intermediate pressure turbine 17 and a low pressure turbine 18, and an exhaust nozzle 19.

The gas turbine engine 10 operates in a conventional manner so that air entering the intake 11 is accelerated by the fan 12 which produce two air flows: a first air flow into the intermediate pressure compressor 13 and a second air flow which provides propulsive thrust. The intermediate pressure compressor compresses the air flow directed into it before delivering that air to the high pressure compressor 14 where further compression takes place.

The compressed air exhausted from the high pressure compressor 14 is directed into the combustor 15 where it is mixed with fuel and the mixture combusted. The resultant hot combustion products then expand through, and thereby drive, the high, intermediate and low pressure turbines 16, 17 and 18 before being exhausted through the nozzle 19 to provide additional propulsive thrust. The high, intermediate and low pressure turbines 16, 17 and 18 respectively drive the high and intermediate pressure compressors 14 and 13 and the fan 12 by suitable interconnecting shafts 26, 28, 30.

Turning to the remaining drawings, examples of the present invention will now be described in more detail with reference to turbine blades, such as those in the turbines 16, 17 and 18. It is to be understood that the invention can also be applied to compressor blades.

FIG. 2 shows a rotor blade 32, in this case a turbine blade, which has a root 34 mounted to a rotor 36. An aerofoil portion 38 extends generally radially away from the rotor 36. The aerofoil portion 38 extends to the tip region 40 of the blade 32. The aerofoil portion 38 interacts with passing combustion gases, during use, to drive the rotor 36 (in the case of a turbine blade), or to compress the combustion gases (in the case of a compressor blade).

The tip region 40 has features to provide shrouding, to reduce over-tip leakage losses associated with combustion gases passing around the tip of the blade 32. Two winglets 42 (FIG. 3) project generally transversely from the tip of the aerofoil portion 38, to respective winglet edges 44. The winglets 42 project, respectively, from the pressure face 46 and the suction face 48 of the aerofoil portion 38.

A gutter 50 extends across the radially outer face of the tip 40. The presence of the gutter 50 assists in reducing over-tip leakage and associated losses. The presence of the gutter 50 leaves upstands 52 between each winglet edge 44 and the gutter 50.

FIG. 4 shows a cross-section of the aerofoil portion 38, partway between the root 34 and the tip 40. A number of voids 54, 56 are present within the body of the blade 32, extending generally radially along the aerofoil portion 38. The voids 54, 56 may be formed in various ways. For example, the blade 32 may be cast around a ceramic core which is removed after casting, to leave the voids 54, 56. The voids 54, 56 are provided for various reasons. They reduce the weight of the blade 32. They also provide passages through which cooling air can be provided from a supply within the rotor 36, to cooling holes (not shown in FIGS. 2 to 4) at the surface of the blade 32.

Cooling arrangements within the tip 40 can now be described in more detail, with particular reference to FIGS. 5, 6 and 7. Cooling arrangements for the blade surface at the winglet edges 44 are provided by cooling air feed galleries 58, cooling passages 60 and cooling holes 62. The galleries 58 are in communication with the void 56, and with the cooling holes 62, through the passages 60.

FIG. 6 is an elevation of the trailing edge 64 of the blade 32, in the region of the tip 40. The small thickness of the trailing edge 66 of the aerofoil portion 38 is apparent, as is the small thickness of the floor 68 of the gutter 50, between the gutter 50 and the underside 70 of the winglets 42. By contrast, the cross-section of the upstands 52 presents a relatively large body of material, in cross-section.

In the example of FIG. 5, a feed gallery 58 is provided through each upstand 52. Each feed gallery 58 is substantially straight and extends along the corresponding upstand 52, alongside the gutter 50. The feed galleries 58 are substantially uniform in cross-section along their length. The galleries 58 extend from the trailing edge 64 to the upper extremity of the void 56. The void 56 is bifurcated at its upper extremity, to provide two arms 72 extending into respective upstands 52, as can be seen from FIG. 6, in which the section of the void 56, including the arms 72, is overlaid in broken lines, on the outline of the blade 32 at the trailing edge 64. The void 56 and its bifurcated arms 72 are spaced from the trailing edge 64, by the length of the galleries 58, as can clearly be seen from FIG. 5. The separation of the void 56 from the trailing edge 64 can also be seen in FIG. 4. This spacing places the void 56 and its bifurcated arms 72 at a position at which the blade 32 is thicker, as can be understood from FIG. 6, in which the broken line outline of the void 56 and arms 72 lies outside the outline of the trailing edge 64.

In this example, the galleries 58 are plugged at the trailing edge 64 by plugs 74, which may have bleed holes 76 to allow cooling air to pass from the gallery 58, through the plug 74, to the trailing edge 64.

It can be seen clearly from FIGS. 5 and 6, particularly FIG. 6, that the feed galleries 58 are substantially wholly defined within the corresponding upstand 52. That is, the outline of the gallery 58 is wholly contained within the outline of the upstand 52, above the level of the gutter floor 68. In an alternative, the gallery 58 may be defined in part within the upstand 52, and may extend below the level of the gutter floor 68. In either alternative, the cross-section of the gallery 58 makes use of the cross-section of the upstands 52, to provide large gallery cross-sections without requiring the gutter floor 68 to be thicker than is required for other reasons.

Along the length of the galleries 58, the cooling passages 60 branch off the gallery 58 to provide communication from the gallery 58 to the cooling holes 62, at the winglet edges 44. Consequently, cooling air which is provided, in use, from the void 56 through the upper arms 72 to the galleries 58 can pass along the cooling passages 60 to the cooling holes 62 and then leave the blade 32 to provide cooling at the surface of the blade, around the holes 62.

Spacing the void 56 and the arms 72 from the trailing edge 66 allows the void 56 and the arms 72 to have a cross-section which is adequately large for supplying sufficient cooling air and cooling air pressure to the galleries 58, without requiring the gutter floor 68 to be thicker than is required for other reasons.

The cooling passages 60 are straight in this example, and are significantly narrower than the gallery 58. The relative width of the galleries 58 allows sufficient static pressure of cooling air to be maintained within the galleries 58, to provide adequate supply to all of the cooling passages 60 and cooling holes 62.

The blade 32 can be manufactured, in one example, in the following manner.

An initial casting step is used to form the main features of the blade 32, including the voids 54, 56. These are provided by the inclusion of a ceramic core of appropriate form, as noted above. The upper arms 72 of the void 56 can conveniently be provided as part of this casting step, by providing appropriate extensions to the ceramic core. The gutter 50 may be formed as part of the casting step, or by subsequent machining. At this point in the process, the upstands 52 remain solid.

After the main features of the blade 32 have been formed, including the winglets 42 and the gutter 50, the galleries 58 are formed by drilling into the upstands 52 from the trailing edge 64 until the corresponding arm 72 is reached. This drilling step results in the galleries 58 being straight and of uniform cross-section.

Having formed the galleries 58, further drilling steps are used to form the cooling holes 62 and the cooling passages 60 by drilling into the winglet edges 44 until the corresponding gallery 58 is reached. Again, the use of a drilling step results in the cooling passages 66 being straight and of uniform cross-section.

The mouths of the galleries 58, at the trailing edge 64, are fitted with the plugs 74. The plugs 74 may be drilled prior to fitting, or after fitting, to provide bleed holes 76 at the trailing edge 64. Thus, at least one cooling hole, i.e. the bleed hole 76, is formed at the trailing edge 64.

The provision of cooling at, and in the region of the trailing edge of the winglets, allows the blade to be cooled in a region which typically becomes very hot during use and is therefore expected to increase the life of the blade by reducing fatigue cracking and oxidation in this region of the blade. This cooling is achieved without the tip mass of the blade being unacceptably affected. The high shafts speeds in high-pressure turbine blades, in particular, mean that even relatively small reductions in tip mass can have a significant benefit in blade life. The mass could be further reduced by forming blind cavities in the winglets. In the examples described, blade tip mass is primarily dictated by the structural requirements of the winglets. The cooling arrangements tend to reduce blade tip mass.

Many variations and modifications can be made to the examples described above, without departing from the scope of the invention, as defined in the accompanying claims. For example, many different shapes, forms and sizes of the features described could be used. Other fabrication techniques could be used instead of casting and drilling. Straight cooling passages of constant cross-section, and straight feed galleries of constant cross-section, allow for drilling as a convenient fabrication technique. Other forms could be used for cooling passages and feed galleries, with alternative fabrication techniques. A feeding gallery for cooling air could be provided for the pressure side winglet, or for the suction side winglet, or for both (as described).

The turbine blades described above can be used in aero engines, marine engines or industrial engines, or for power generation.

1. A rotor blade comprising:
an aerofoil portion which extends radially to a tip;
a winglet at the tip and projecting transversely, to a winglet edge, to shroud the tip;
a gutter extending across the radially outer face of the tip;
the winglet providing an upstand between the winglet edge and the gutter;
and the blade further comprising a cooling air feed gallery and at least one cooling passage extending from the feed gallery to a cooling hole at an outer surface of the blade;
wherein the feed gallery is defined, at least in part, within the upstand.

2. A blade according to claim 1, wherein the feed gallery is defined substantially wholly within the upstand.

3. A blade according to claim 1, wherein the feed gallery extends within the upstand, alongside the gutter.

4. A blade according to claim 1, wherein the feed gallery is straight.

5. A blade according to claim 1, wherein the feed gallery has substantially uniform cross-section.

6. A blade according to claim 1, wherein the feed gallery extends to the trailing edge of the blade.

7. A blade according to claim 6, wherein the feed gallery is closed at the trailing edge.

8. A blade according to claim 1, wherein the feed gallery communicates with a void within the blade, to receive cooling air, in use, from the void.

9. A blade according to claim 8, wherein the void is spaced from the trailing edge of the blade.

10. A blade according to claim 8, wherein the void extends generally radially through the blade, toward the tip, and into the upstand.

11. A blade according to claim 1, wherein the or each cooling passage is substantially straight.

12. A blade according to claim 1, wherein the or each cooling passage is narrower than the feed gallery.

13. A blade according to claim 1, wherein at least one cooling passage extends to a cooling hole in the winglet edge.

14. A blade according to claim 1, wherein cooling air from the feed gallery is supplied to at least one cooling hole at the trailing edge of the blade.

15. A blade according to claim 1, wherein the blade comprises winglets extending from the pressure face and the suction face of the blade, to provide respective upstands between the gutter and respective winglet edges, there being feed galleries, as aforesaid, defined, at least in part, within each upstand.

16. A method of manufacturing a rotor blade, in which:
an aerofoil portion is provided, extending radially to a tip;
a winglet is provided at the tip and projecting transversely, to a winglet edge, to shroud the tip;
a gutter is provided across the radially outer face of the tip, so that the winglet provides an upstand between the winglet edge and the gutter;
and a cooling air feed gallery and at least one cooling passage are provided within the blade, the or each cooling passage extending from the feed gallery to a cooling hole at an outer surface of the blade;
and wherein the feed gallery is formed, at least in part, within the upstand.

17. A method according to claim 16, wherein the feed gallery is formed substantially wholly within the upstand.

18. A method according to claim 16, wherein the feed gallery is formed to extend within the upstand, alongside the gutter.

19. A method according to claim 16, wherein the feed gallery is formed to be straight.

20. A method according to claim 16, wherein the feed gallery is formed to have substantially uniform cross-section.

21. A method according to claim 16, wherein the feed gallery is formed by drilling.

22. A method according to claim 16, wherein the feed gallery extends to the trailing edge of the blade.

23. A method according to claim 22, wherein the feed gallery is closed at the trailing edge.

24. A method according to claim 16, wherein the feed gallery communicates with a void within the blade, to receive cooling air, in use, from the void.

25. A method according to claim 24, wherein the void is spaced from the trailing edge of the blade.

26. A method according to claim 24, wherein the void extends generally radially through the blade, toward the tip, and into the upstand.

27. A method according to claim 24, wherein the void is cast into the blade, when the blade is formed.

28. A method according to claim 16, wherein the or each cooling passage is substantially straight.

29. A method according to claim 16, wherein the or each cooling passage is formed by drilling.

30. A method according to claim 16, wherein the or each cooling passage is narrower than the feed gallery.

31. A method according to claim 16, wherein at least one cooling passage extends to a cooling hole in the winglet edge.

32. A method according to claim 16, wherein cooling air from the feed gallery is supplied to at least one cooling hole at the trailing edge of the blade.

33. A method according to claim 16, wherein the blade is provided with winglets extending from the pressure face and the suction face of the blade, to provide respective upstands between the gutter and respective winglet edges, feed galleries, as aforesaid, being provided, at least in part, within each upstand.
